(19) United States
(12) Patent Application Publication
(10) Pub. No.: US 2019/0023897 A1
(43) Pub. Date: Jan. 24, 2019

(54) HIGH TEXTURE REPLICATION RATE SHEET COMPOSITIONS, METHODS OF MANUFACTURE, AND ARTICLES MADE THEREFROM

(71) Applicant: SABIC GLOBAL TECHNOLOGIES B.V., Bergen op Zoom (NL)

(72) Inventors: Yafeng Sun, Shanghai (CN); Liang Wen, Shanghai (CN); Zhe Chen, Shanghai (CN)

(21) Appl. No.: 16/064,282

(22) PCT Filed: Dec. 21, 2016
(86) PCT No.: PCT/IB2016/057894

§ 371 Date: Jun. 20, 2018

Related U.S. Application Data
(60) Provisional application No. 62/270,613, filed on Dec. 22, 2015.

(51) Int. Cl. C08L 69/00; C08L 67/02; C08J 5/18; B29C 47/00; B29C 59/00; B29C 47/88

(52) U.S. Cl. CPC C08L 69/00; B29K 2069/00; C08J 5/18; B29C 47/0004; B29C 47/0061; B29C 59/002; B29C 47/884; C08L 2201/08; C08L 2203/16; C08L 2205/025; C08L 2205/03; C08J 2369/00; C08J 2367/02; C08J 2467/02; C08J 2469/00; C08L 67/02

(57) ABSTRACT

A replication composition includes at least 45 weight percent (wt) of a polycarbonate; 3 to 55 wt % of a polyester comprising a poly(C₁₋₆ alkylene) terephthalate or a polyester comprising repeating units of Formula I: (I); wherein each T is independently a C₅₋₇ cycloaliphatic group or C₆₋₁₂aromatic group, and each D is independently a C₆₋₁₂ aromatic group or C₂₋₁₂ aliphatic group, provided that at least 50 mole percent of D is a 1,4-cyclohexanedimethyl group or a C₂₋₁₂ aliphatic group; wherein the polyester has a melt viscosity between 0.01 and 3,000 poise (0.001 and 300 Pa·s) measured at 1500/seconds shear rate, at a temperature of 275° C.; and 0.01 to 4 wt % additives; wherein the weight percentages are based on 100 wt % of the composition.

### BACKGROUND

Optical sheets that have micro structure surface textures can have specialized functions, such as light guiding or light diffusing. These micro structure surface textured optical sheets can be used in display and lighting applications, including back light modules and light emitting diode (LED) light covers. Thermoplastic polymers can be processed by methods such as a calendaring extrusion process to obtain a sheet with a micro structure surface texture. The surface texture replication rate (or replication rate) is used to express the percentage of texture on the sheet as compared to a master roll. Typically, the higher the replication rate, the better performance the sheet will have in applications. A lower replication rate limits the product performance for light guiding or diffusing performance, for example. Processing conditions and materials used are important factors in the replication rate. There remains a need for a composition that can be used to produce thermoplastic sheets with high surface texture replication rates.

### BRIEF DESCRIPTION

Disclosed herein are replication compositions, articles made from such compositions, and methods for the manufacture and use thereof. The replication compositions can be used to make thermoplastic sheets or films with a high replication rate. The sheet can be a monolithic sheet or a coextruded sheet with a core layer and a cap layer that can have different melt rheology characteristics than the core layer.

A replication composition includes at least 45 weight percent (wt %) (e.g., 45 wt % to 96 wt %) of a polycarbonate; 3 to 55 wt % of a polyester comprising a poly(C₁₋₆ alkylene) terephthalate or a polyester including repeating units of Formula 1:

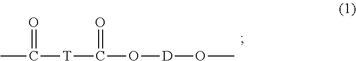

wherein each T is independently a C₅₋₇ cycloaliphatic group or C₆₋₁₂ aromatic group, and each D is independently a C₆₋₁₂ aromatic group or C₂₋₁₂ aliphatic group, provided that at least 50 mole percent of D is a 1,4-cyclohexanedimethyl group or a C₂₋₁₂ aliphatic group; wherein the polyester has a melt viscosity between 0.01 and 3,000 poise (0.001 and 300 Pa·s), measured at 1,500/seconds shear rate, at a temperature of 275° C.; and 0.01 to 4 wt % additives; wherein the weight percentages are based on 100 wt % of the composition.

A method of manufacturing a textured sheet includes providing a replication composition; heating the replication composition to an extrusion temperature of greater than or equal to a glass transition temperature of the replication composition; extruding the replication composition through a die to form a sheet; imprinting a surface texture from a transfer surface onto the sheet; and cooling the sheet below a glass transition temperature of the replication composition to form a textured sheet.

A textured sheet includes an extruded sheet formed from a replication composition, wherein a side of the extruded sheet includes a surface texture including a plurality of micro-structured units. Articles including a textured sheet are also described.

The above described and other features are exemplified by the following figures and detailed description.

### BRIEF DESCRIPTION OF THE DRAWING

The following Drawing is exemplary.

FIG. 1 is an example of a calendaring extrusion system.

FIG. 2 is an exploded view of part of one of the calendaring rolls from FIG. 1.

### DETAILED DESCRIPTION

“Polycarbonate” as used herein means a polymer or copolymer including repeating structural carbonate units of the formula (2)

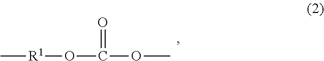

wherein at least 60 percent of the total number of R¹ groups are aromatic, or each R¹ contains a C₆₋₃₀ aromatic group. A polycarbonate includes, e.g., repeating structural carbonate units of Formula (5):

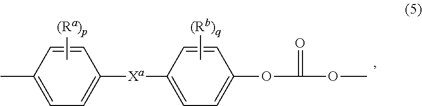

where R^{a} and R^{b} are each independently a halogen atom or a monovalent hydrocarbon group with from 1 to 12 carbon atoms and can be the same or different; p and q are each independently integers from 0 to 4; and each X^{a} is independently one of the groups:

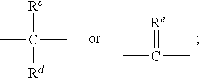

wherein R^{c} and R^{d} are each independently a hydrogen atom or a monovalent linear hydrocarbon group with from 1 to 12 carbon atoms, or a cyclic hydrocarbon group with from 7 to 12 carbon atoms, and R^{E} is a divalent hydrocarbon group with from 1 to 12 carbon atoms.

Polycarbonates and their methods of manufacture are known in the art, being described, for example, in WO 2013/175448 A1, US 2014/0295363, and WO 2014/072923. Polycarbonates are generally manufactured from bisphenol compounds such as 2,2-bis(4-hydroxyphenyl) propane (“bisphenol-A” or “BPA”), 3,3-bis(4-hydroxyphenyl) phthalimidine, 1,1-bis(4-hydroxy-3-methylphenyl)cyclohexane, or 1,1-bis(4-hydroxy-3-methylphenyl)-3,3,5-trimethylcyclohexane, or a combination comprising at least one of the foregoing bisphenol compounds can also be used. A polycarbonate is, e.g., a homopolymer derived from BPA; a copolymer derived from BPA and another bisphenol or dihydroxy aromatic compound such as resorcinol; or a copolymer derived from BPA and optionally another bisphenol or dihydroxyaromatic compound, and further comprising non-carbonate units, for example aromatic ester units such as resorcinol terephthalate or isophthalate, aromatic-aliphatic ester units based on C₆₋₂₀ aliphatic diacids, polysiloxane units such as polydimethylsiloxane units, or a combination comprising at least one of the foregoing.

The polycarbonate can be present in the composition in an amount of at least 40 wt %, for example, 45 wt % to 96 wt %, or 45 wt % to 93 wt %, or 45 wt % to 80 wt %, or even 50 wt % to 0 wt %, wherein the weight percentages are based on 100 wt % of the composition.

The polycarbonate can have a weight average molecular weight (Mw) between 5,000 Daltons and 60,000 Daltons, preferably 15,000 Daltons to 35,000 Daltons, or preferably 18,000 Daltons to 33,000 Daltons, as determined using gel permeation chromatography (GPC) with polycarbonate standard.

“Polyester” as used herein is a poly(C₁₋₆ alkylene) terephthalate or a polyester including repeating ester units of formula (1):

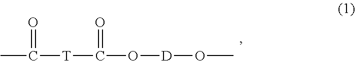

wherein each T is independently a C₅₋₇ cycloaliphatic group or C₆₋₁₂ aromatic group, and each D is independently a C₆₋₁₂ aromatic group or C₂₋₁₂ aliphatic group, provided that at least 50 mole percent of D is a 1,4-cyclohexanedimethyl group or a C₂₋₁₂ aliphatic group. Copolyesters containing a combination of different T and/or D groups can be used. The polyester units can be cyclic or branched or linear.

In the replication composition, the polyester can have a melt viscosity between 0.01 and 3,000 poise (0.001 and 300 Pa·s), preferably between 0.02 and 2,600 poise (0.002 and 260 Pa·s), measured at 1500/seconds (sec) shear rate at a temperature of 275° C.

One example of a polyester is a poly(alkylene) terephthalate, preferably a cyclic (C₁₋₆ alkylene) terephthalate. Representative examples of poly(alkylene) terephthalates include a compound including a structural unit of formula (7):

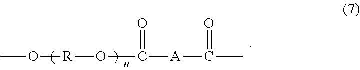

In formula (7), R is a C₁₋₆ alkylene group such as ethylene group, propylene group, or butylene group (particularly a straight chain C₁₋₆ alkylene group), preferably a C₂₋₆ alkylene group, preferably a C₂₋₄ alkylene group; A is a bivalent aromatic group, including a C₆₋₁₂ arylene group such as a phenylene group (e.g., m-phenylene group and p-phenylene group), preferably a C₆₋₁₀ arylene group, preferably a C₆₋₈ arylene group; and the number n denotes an integer from 1 to 4. One example of a cyclic poly(C₁₋₆ alkylene) terephthalate is cyclic poly(butylene terephthalate). The average degree of polymerization of the poly(alkylene) terephthalate can be 1 to 30, preferably about 2 to 25, preferably about 3 to 20, preferably about 4 to 18, preferably about 2 to 15. The poly(alkylene) terephthalate can be a mixture of cyclic oligomers with various degrees of polymerization. The melting point of the cyclic poly(alkylene) terephthalate can be 100 to 250° C., preferably 110 to 220° C., preferably 120 to 210° C., preferably 130 to 200° C. One cyclic poly(alkylene) terephthalate is cyclic poly(butylene) terephthalate oligomer (CBT).

Other polyesters include at least one cycloaliphatic moiety, for example, poly(cyclohexane-1,4-dimethylene cyclohexane-1,4-dicarboxylate) (also referred to as poly(1,4-cyclohexane dimethanol dimethyl 1,4-cyclohexane dicarboxylate) (PCCD)).

Other polyesters are copolyesters derived from an aromatic dicarboxylic acid and a mixture of linear aliphatic diols (specifically ethylene glycol, butylene glycol, poly(ethylene glycol) or poly(butylene glycol)) together with cycloaliphatic diols. The ester units comprising the linear aliphatic or cycloaliphatic ester units can be present in the polymer chain as individual units, or as blocks of the same type of units. A specific polyester of this type is poly(1,4-cyclohexylene dimethylene co-ethylene terephthalate) (also referred to as poly(ethylene glycol terephthalate-co-cyclohexanedimethylene terephthalate) (PCTG)).

A polyester can be a poly(C₁₋₆ alkylene) terephthalate or poly(cyclohexane di(C₁₋₆ alkanol) cyclohexyl dicarboxylate) or a copolymer comprising a poly(C₁₋₆ alkylene)glycol terephthalate and a poly(cyclohexane di(C₁₋₆ alkylene) terephthalate). A polyester can be a cyclic poly(butylene terephthalate), a poly(ethylene glycol terephthalate-co-cyclohexanedimethylene terephthalate, or a poly(1,4-cyclohexane dimethanol dimethyl 1,4-cyclohexane dicarboxylate).

Polyesters can be obtained by interfacial polymerization or melt-process condensation, by solution phase condensation, or by transesterification polymerization wherein, for example, a dialkyl ester such as dimethyl terephthalate can be transesterified with ethylene glycol using acid catalysis, to generate poly(ethylene terephthalate). A branched polyester can be used in which a branching agent, for example, a glycol having three or more hydroxyl groups, or a trifunctional or multifunctional carboxylic acid has been incorporated. Furthermore, it is sometimes desirable to have various concentrations of acid and hydroxyl end groups on the polyester, depending on the ultimate end use of the composition. Recycled polyesters and blends of recycled polyesters with virgin polyesters can also be used.

The polyester can be present in the composition in an amount of 3 wt % to 55 wt %, for example, 10 wt % to 50 wt %, or 19 to 55 wt %, or 19 wt % to 48 wt %, wherein the weight percentages are based on 100 wt % of the composition.

The replication composition includes from 0.01 to 4 wt % additives, or 0.01 to 3 wt % additives, or 0.01 to 2 wt % additives, wherein the weight percentages are based on 100 wt % of the composition. In other words, the total amount of additives in the composition is 0.01 to 4 wt %. The additives can be UV stabilizers, phosphorous stabilizers, heat stabilizers, antioxidants, hydrolytic stabilizers, mold release agents, extrusion aids, antistatic agents, quenchers, antistatic agents, quenchers, slip agents, coloring agents (e.g., a dye or a pigment), lubricants, or a combination comprising at least one of the foregoing. The additives can be an antistatic agent, a quencher, an antioxidant, a mold release agent, a UV stabilizer, or a combination comprising at least one of the foregoing. The additives can be glycerol monostearate, pentaerythritol tetrastearate, a phosphite stabilizer, or a combination comprising at least one of the foregoing.

An extruded sample of the composition can have a transmission greater than or equal to 80%, preferably greater than 90%. As use herein, unless expressly specified otherwise, transmission is determined according to ASTM D1003-00, Procedure A, using D65 illumination, with a sample having a thickness of 2.54 millimeters (mm).

The replication composition can be used to manufacture a textured sheet by a method including: providing a replication composition; heating the replication composition to an extrusion temperature of greater than or equal to a glass transition temperature of the replication composition; extruding the replication composition through a die to form a sheet; imprinting a surface texture from a transfer surface onto the sheet; and cooling the sheet below a glass transition temperature of the replication composition to form a textured sheet. In the method of manufacturing a textured sheet, imprinting occurs before the replication composition is cooled below a glass transition temperature of the replication composition. Imprinting can include pressing the sheet between two or more surfaces at a transfer pressure, wherein one of the surfaces comprises the transfer surface. Imprinting can include pressing the sheet between two or more rollers at a transfer pressure, wherein a roller contains the transfer surface disposed along a roller surface. Imprinting can include pressing the sheet between a master roller and a compliant roller at a transfer pressure, wherein the master roller contains the transfer surface disposed along a roller surface. The pressure between the master roller and compliant roller, also known as the nip pressure, can be 3 to 50 Bar, preferably 10 to 40 Bar.

Imprinting can include transferring the surface texture to the sheet with a replication rate of greater than or equal to 70%, preferably greater than or equal to 80%, preferably greater than or equal to 90%. Cooling can occur within any period of time after imprinting that allows the surface texture to maintain the desired form at the desired level. Cooling can occur, e.g., 0.01 to 5 minutes after imprinting. Cooling can be at any rate that provides the desired effect. Cooling can be at a rate of 5 to 300° C./minute, preferably from 5 to 200° C./minute.

The textured sheet can include, e.g., a cap layer in contact with the replication composition. The cap layer can be a layer of a second composition in direct contact with the replication composition, wherein the second composition includes a replication composition as described herein, or a polyarylate, a polystyrene, a polyester, or a combination comprising at least one of the foregoing. The cap layer can be the same or different thickness as the textured sheet made from the replication composition.

Also provided is a textured sheet made by a method described herein. Also provided is an article including a textured sheet as described herein. The article can be a light module, an LED light cover, a diffuser/collimating sheet in a back light module in a display application, or a reflective film in a sign application, for example.

The texture on the textured sheet or article can be of any suitable feature shape and size to provide the desired optical function. The texture can include repeating features. The texture can be microscale in size, including elements that are 1 to less than 1,000 micrometers (μm), preferably from 10 to 500 μm, preferably from 100 to 250 μm in one or more dimensions. Each dimension (e.g., height or width or depth) of the features can be any suitable size to permit the desired optical function. Each dimension of the features can be the same or different. The features can be present in a regular or semi-regular pattern on the textured sheet. The textured sheet can include a pattern with a uniform appearance to provide the desired function, for example, to diffuse or guide light evenly and minimize undesirable effects such as interference or light. The features can have a shape including lenses, prisms, semicircles, semi-ovals, polyhedral shapes, lenticular shapes, crossing prismatic shapes, pyramidal shapes, corner cubes, cones, or a combination comprising at least one of the foregoing.

The description is further illustrated by the following non-limiting examples.

### EXAMPLES

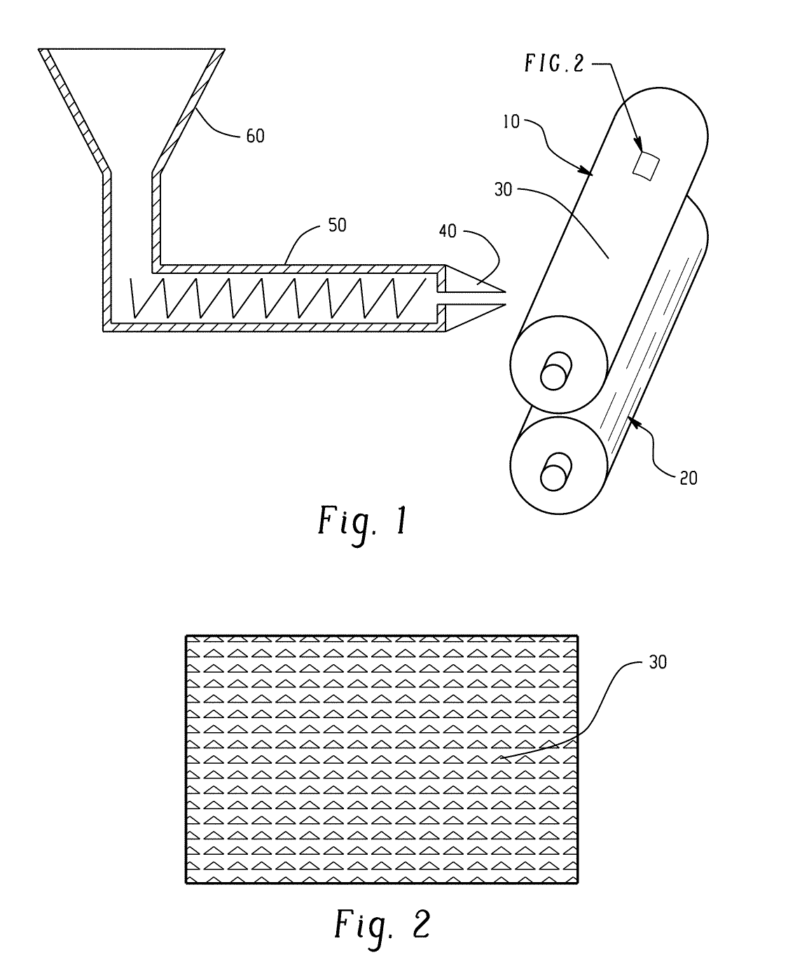

An extrusion system is shown in FIG. 1, which has hopper (60) and screw extruder (50). Molten polymeric material exiting die (40) is dumped into the nip between master roller (10) and compliant roller (20), where a moderate pressure is applied to the melt. Nip roller pair includes master roller (10) with texture (30) (such as a microlens texture) at the roller surface and compliant roller (20) with a matte or polish surface. The web with the replicated texture leaves the nip and is immediately cooled below a glass transition temperature of the polymer, allowing the polymer to solidify while still including the texture.

The sheet can be a monolithic sheet or a coextruded sheet that includes two or more layers, where the top layer which is in contact with master texture roller is made of the replication composition described here and the core layer can be made of the same or different material and can be the same or different thickness as the top layer.

In the below examples, a sheet was formed from a replication composition by mixing the indicated materials within the extrusion barrel of a TEM-37BS (Twin) screw extruder before passing through a 3 millimeter extrusion die. The extruder had a 1,500 millimeter (mm) barrel with 12 temperature zones along its length. The barrel zone temperatures and die temperatures are shown in Table 1. The extruder had an L-3-1B screw operating at 400 revolutions per minute (rpm) with a throughput of 40 kilograms per hour (kg/hr), and operated at 30% of maximum torque. The extruder included a vacuum operated at a gauge (g) pressure of −0.08 Mega Pascal (MPa (g)).

The extruded sheet was pressed between a master roller including a ceramic transfer surface and a steel roller opposing the master roller. The transfer surface had micro-structure units in the form of microlenses with a unit lens diameter of about 150 micrometers (μm) engraved in the ceramic surface.

TABLE 1
Barrel Zone and Die Temperatures

| Barrel Zone | Temp |
|---|---|
| 1 | 50° C. |
| 2 | 100° C. |
| 3 | 270° C. |
| 4 | 270° C. |
| 5 | 270° C. |
| 6 | 270° C. |
| 7 | 270° C. |
| 8 | 270° C. |
| 9 | 270° C. |
| 10 | 270° C. |
| 11 | 270° C. |
| 12 | 270° C. |
| Die Temp | 270° C. |

TABLE 2
Testing Procedures

| | | | Specimen | |
|---|---|---|---|---|
| Property | Standard | Conditions | Type | Units |
| MFR | ASTM D1238-04 | 300° C., 1.2 | Granule | cm³/10 |
| | | Kilograms | | mins |
| Transmission | ASTM D1003-00, | 2.54 mm thick | film | % |
| | Procedure A, D65 | sample; | | |
| | illumination | HazeGard II | | |
| Haze | ASTM D1003-00, | 2.54 mm thick | film | % |
| | Procedure A, D65 | sample; | | |
| | illumination | HazeGard II | | |
| Mw | GPC | Polycarbonate | | |
| | | Standard | | |

TABLE 3
Materials

| Component | Trade name; chemical description | Source |
|---|---|---|
| PC-1 | Linear Bisphenol-A polycarbonate having a Mw of about 29,900 | SABIC |
| | Dalton | |
| PC-2 | Bisphenol-A polycarbonate having a Mw of about 21,900 Dalton | SABIC |
| PC-3 | Bisphenol-A polycarbonate having a Mw of about 17,700 Dalton | SABIC |
| PA | Quencher, 10% phosphoric acid diluted in water | Fisher |
| | | Scientific |
| Stabilizer-1 | Antioxidant, Tris(2,4-di-tert-butylphenyl)phosphite | Ciba |
| Stabilizer-2 | Antioxidant, Phosphonous acid ester, PEPQ powder (IRGAFOS | Ciba |
| | P-EPQ) (Tetrakis(2,4-di-tert-butylphenyl)-4,4- | |
| | biphenyldiphosphonite) | |
| PETS | Mold release agent, Pentaerythritol tetrastearate | Faci |
| Cesa | Chain Extender, ADR4368, Styrene-acrylate-epoxy oligomer | BASF |
| UV | UV light Absorber, UVA235, 2-(2′hydroxy-5-t-octylphenyl)- | BASF |
| | benzotriazole | |
| GMS | Antistatic agent, Rikemal S-100A, Glycerol monostearate | Riken |
| | | Vitamin co. |
| PCCD | Poly(1,4-cyclohexane dimethanol dimethyl 1,4-cyclohexane | Eastman |
| | dicarboxylate), 2000 poise viscosity 1500/sec. shear rate at a | Chemical |
| | temperature of 275° C., inherent viscosity 0.75 deciliter | |
| | (DL)/gram | |
| | 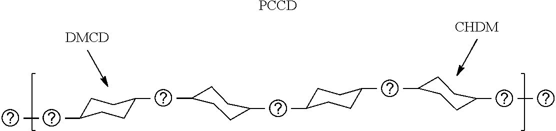 | |
| PCTG | Poly(ethylene glycol terephthalate-co-cyclohexanedimethylene | Eastman |
| | terephthalate), 2600 poise viscosity 1500/sec. shear rate at a | Chemical |
| | temperature of 275° C., inherent viscosity 0.87 DL/gram 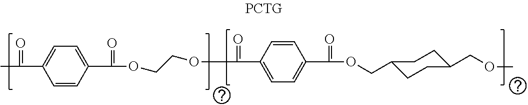 | (as Eastar 10179) |
| CBT100 | Cyclic form of polybutylene terephthalate 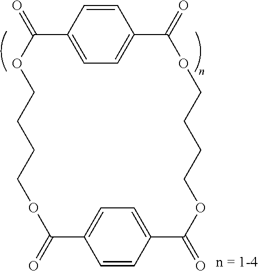 | Cyclics corporation |
| | 0.05 poise viscosity 1500/sec. shear rate at a temperature of | |
| | 275° C., 0.12 poise viscosity 101/sec. shear rate at 220° C. | |

Table 4 lists the formulation compositions for each example sheet and the replication rate obtained for about 0.8 mm thick sheets. Replication rate is defined as the ratio of unit structure on the sheet to the master rolls. The height or other parameter can be measured by optical microscope, scanning electron microscope (SEM), or surface morphology detector. The replication rate of the examples described here was measured using an optical microscope. Texture height was used in these examples to measure replication rate. The thickness of the film is an average of 10 points, measuring from the top of the unit structure to the bottom of the film. The average height of the microlenses pressed onto the film along an area of the film was compared to the average height of the microlenses of the transfer surface on the master roller along an area of the transfer surface, where the area of the film and the area of the transfer surface were in direct contact during the pressing process.

TABLE 4
Example Compositions and Property Testing

| Material | C. | C. | | | | | | |
|---|---|---|---|---|---|---|---|---|
| Description | Ex. 1 | Ex. 2 | Ex. 3 | Ex. 4 | Ex. 5 | Ex. 6 | Ex. 7 | Ex. 8 |
| PC-3 | | 99.86 | 95.183 | 89.86 | 79.86 | 81.645 | 72.557 | |
| Stabilizer-1 | 0.13 | 0.06 | 0.057 | 0.06 | 0.06 | 0.055 | 0.056 | |
| CBT100 | | | 4.76 | 10 | 20 | | | |
| GMS | | 0.08 | | 0.08 | 0.08 | 0.073 | 0.073 | |
| PCCD | | | | | | 18.18 | 27.27 | |
| PA | | | | | | 0.045 | 0.045 | 0.06 |
| PC-1 | 99.71 | | | | | | | 40.7 |
| PC-2 | | | | | | | | 10 |
| PCTG | | | | | | | | 48 |
| Stabilizer-2 | | | | | | | | 0.09 |
| PETS | 0.06 | | | | | | | 0.15 |
| Cesa | | | | | | | | 0.25 |
| UV | | | | | | | | 0.25 |
| Water | 0.01 | | | | | | | 0.5 |
| MFR | 6.8 | 56 | 80.9 | 95.9 | MFR too high | 58.4 | 62.1 | 10 |
| | | | | | cannot be | | | |
| | | | | | tested at this | | | |
| | | | | | condition | | | |
| Transmission % | 89 | 90.1 | 91 | 91 | 89.2 | 87.7 | 89.7 | 89 |
| Haze % | | 3.5 | 0.7 | 0.8 | 1.2 | 1.4 | 2.1 | 2 |
| Replication Rate | 52 | 52.7 | 61.3 | 77.5 | 91.9 | 65.5 | 84.8 | 80.7 |
| (micro-lens | | | | | | | | |
| texture) (%) | | | | | | | | |

A formulation using PC-1 material (C. Ex. 1 in Table 4) was used to optimize the extrusion process and provide a comparison of replication rate for other formulations. In the film or sheet extrusion process, the line speed, nip pressure and master roller temperature are important factors in the texture replication rate. Both a micro lens texture and a prism texture were replicated in these examples. The line speed was set in the range of 1 to 3.8 meters/minute, nip pressure was set in the range of 10 to 40 Bar, and master roller temperature was set in the range of 100 to 130° C. For Comparative Example 1 (C. Ex.1), the best replication rate obtained for micro-lens texture was 52%; the best replication rate for a prism texture obtained was 35%.

Comparative Example 1 (C. Ex. 1) and Comparative Example 2 (C. Ex. 2) indicate that when PC is used alone, the replication rate is low. In examples where CBT100 is added to PC-3 (Ex. 3-5), the replication rate and MFR increase as the amount of CBT100 increases. For example, in Ex. 5, when 20% CBT100 was used, the replication rate was 91.9%.

Ex. 6 and 7 illustrate the performance of a composition containing PC-3 and PCCD, and these examples demonstrate that with a higher PCCD loading, the higher the replication rate and MFR. For example, in Ex. 7, when 27.27% PCCD was blended with PC-3, the replication rate was 84.8%.

Comparative Example 1 (C. Ex. 1) and Example 8 (Ex. 8) in Table 5 indicate that blending PCTG with PC can also improve the replication rate. Ex. 8 uses 48% PCTG and showed an 80.7% replication rate.

The replication composition, articles prepared therefrom, and methods of manufacturing are further illustrated by the following embodiments, which are non-limiting.

Embodiment 1: A replication composition, including at least 45 weight percent (wt %), preferably 45 to 93 wt % of a polycarbonate with a weight average molecular weight (Mw) of 5,000 Daltons to 60,000 Daltons, preferably between 15,000 Daltons and 35,000 Daltons; 3 to 55 wt %, preferably 10 to 50 wt % of a polyester including a poly(C₁₋₆ alkylene) terephthalate or a polyester including repeating units of Formula 1:

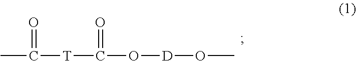

wherein each T is independently a C₅₋₇ cycloaliphatic group or C₆₋₁₂ aromatic group, and each D is independently a C₆₋₁₂ aromatic group or C₂₋₁₂ aliphatic group, provided that at least 50 mole percent of D is a 1,4-cyclohexanedimethyl group or a C₂₋₁₂ aliphatic group; wherein the polyester has a melt viscosity between 0.01 and 3,000 poise (0.001 and 300 Pa·s), preferably between 0.02 and 2,600 poise (0.002 and 260 Pa·s), measured at 1500/seconds shear rate, at a temperature of 275° C.; and 0.01 to 4 wt % additives; wherein the weight percentages are based on 100 wt % of the composition.

Embodiment 2: The replication composition of embodiment 1, wherein the polyester includes a poly(C₁₋₆ alkylene) terephthalate, a poly(cyclohexane di(C₁₋₆ alkanol) cyclohexyl dicarboxylate), or a copolymer including a poly(C₁₋₆ alkylene)glycol terephthalate and a poly(cyclohexane di(C₁₋₆ alkylene) terephthalate).

Embodiment 3: The replication composition of embodiment 1 or 2, wherein the polyester includes a cyclic poly(butylene terephthalate), a poly(ethylene glycol terephthalate-co-cyclohexanedimethylene terephthalate), or a poly(1,4-cyclohexane dimethanol dimethyl 1,4-cyclohexane dicarboxylate).

Embodiment 4: The replication composition of any one or more of embodiments 1 to 3, wherein an extruded sample of the composition with a thickness of 2.54 millimeters (mm) has a transmission greater than or equal to 80%, preferably greater than 90%, according to ASTM D 1003-00, Procedure A, using D65 illumination.

Embodiment 5: The replication composition of any one or more of embodiments 1 to 4, wherein the additives are UV stabilizers, phosphorous stabilizers, heat stabilizers, antioxidants, hydrolytic stabilizers, mold release agents, extrusion aids, antistatic agents, quenchers, slip agents, coloring agents, lubricants, or a combination comprising at least one of the foregoing.

Embodiment 6: The replication composition of any one or more of embodiments 1 to 5, wherein the polycarbonate includes repeating structural carbonate units of Formula (5):

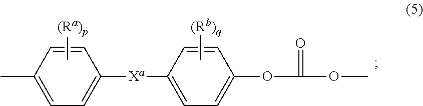

where R^{a} and R^{b} are each independently a halogen atom or a monovalent hydrocarbon group with from 1 to 12 carbon atoms; p and q are each independently integers from 0 to 4; and
each X^{a} is independently one of the groups:

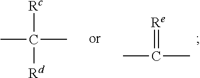

wherein R^{c} and R^{d} are each independently a hydrogen atom or a monovalent linear hydrocarbon group with from 1 to 12 carbon atoms, or a cyclic hydrocarbon group with from 7 to 12 carbon atoms, and R^{e} is a divalent hydrocarbon group with from 1 to 12 carbon atoms.

Embodiment 7: The replication composition of any one or more of embodiments 1 to 6, wherein the additives are one or more of glycerol monostearate, pentaerythritol tetrastearate, and a phosphite stabilizer.

Embodiment 8: The replication composition of any one or more of embodiments 1 to 7, wherein an extruded film including the composition has a replication rate of greater than 75%, preferably greater than 80%, preferably greater than 90%.

Embodiment 9: The replication composition of any one or more of embodiments 1 to 8, wherein an extruded film including the composition has a melt flow rate (MFR) of greater than 50, preferably greater than 55 cubic centimenters per 10 minutes (cm³/10 mins), as measured according to ASTM D1238-04.

Embodiment 10: The replication composition of any one or more of embodiments 1 to 9, wherein a 2.54 mm thick extruded film including the composition has a haze of less than 2.2, preferably less than 1.5, as measured according to ASTM D1003-00, Procedure A, using D65 illumination.

Embodiment 11: The replication composition of any one or more of embodiments 1 to 10, including 45 to 80 weight percent, preferably 50 to 80 weight percent of the polycarbonate; 19 to 55 weight percent, preferably 19 to 48 weight percent of the polyester; and 0.01 to 2 total weight percent of additives.

Embodiment 12: A method of manufacturing a textured sheet including: providing a replication composition including the composition of any one or more of embodiments 1 to 11; heating the replication composition to an extrusion temperature of greater than or equal to a glass transition temperature of the replication composition; extruding the replication composition through a die to form a sheet; imprinting a surface texture from a transfer surface onto the sheet; and cooling the sheet below a glass transition temperature of the replication composition to form a textured sheet.

Embodiment 13: The method of embodiment 12, further including forming a layer of a second composition in direct contact with the replication composition, wherein the second composition includes the composition of any one or more of embodiments 1 to 11, or a polyarylate, a polystyrene, a polyester, or a combination comprising at least one of the foregoing.

Embodiment 14: The method of embodiment 12 or 13, wherein imprinting occurs before the replication composition is cooled below a glass transition temperature of the replication composition.

Embodiment 15: The method of any one or more of embodiments 12 to 14, wherein imprinting includes pressing the sheet between two or more surfaces at a transfer pressure, wherein one of the surfaces comprises the transfer surface.

Embodiment 16: The method of any one or more of embodiments 12 to 15, wherein imprinting includes pressing the sheet between two or more rollers at a transfer pressure, wherein a roller comprises the transfer surface disposed along a roller surface.

Embodiment 17: The method of any one or more of embodiments 12 to 16, wherein imprinting includes transferring the surface texture to the sheet with a replication rate of greater than or equal to 75%, preferably greater than 80%, preferably greater than 90%.

Embodiment 18: The method of any one or more of embodiments 12 to 17, wherein cooling occurs within 0.01-5 minutes of imprinting.

Embodiment 19: The method of any one or more of embodiments 12 to 18, wherein cooling is at a rate of 5-300° C./minute.

Embodiment 20: A textured sheet made by the method of any one or more of embodiments 12 to 19.

Embodiment 21: The textured sheet of embodiment 20, wherein a side of the extruded sheet comprises a surface texture comprising a plurality of micro-structured units.

Embodiment 22: The textured sheet of embodiment 20 or 21, further comprising a second composition in direct contact with a side of the extruded sheet, wherein the second composition comprises the composition of any of embodiments 1-11 or a polycarbonate, a polyarylate, a polystyrene, a polyester, or a combination of at least one of the foregoing.

Embodiment 23: The textured sheet of any of embodiments 20-22, further comprising a second composition in direct contact with a side of the extruded sheet, wherein the second composition is different than the composition of the extruded sheet.

Embodiment 24: An article including the textured sheet of any one or more of embodiments 20-23.

Embodiment 25: The article of embodiment 24, wherein the article is a light module, an LED light cover, or a diffuser/collimating sheet in a back light module in a display application.

Embodiment 26: A textured sheet including: an extruded sheet including at least 45 weight percent (wt %), preferably 45 to 93 wt % of a polycarbonate with a weight average molecular weight between 5,000 Daltons and 60,000 Daltons, preferably between 15,000 Daltons and 35,000 Daltons; 3 to 55 wt %, preferably 10 to 50 wt % of a polyester including a poly(C₁₋₆ alkylene) terephthalate or a polyester including repeating units of Formula 1:

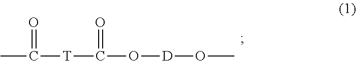

wherein each T is independently a C₅₋₇ cycloaliphatic group or C₆₋₁₂ aromatic group, and each D is independently a C₆₋₁₂ aromatic group or C₂₋₁₂ aliphatic group, provided that at least 50 mole percent of D is a 1,4-cyclohexanedimethyl group or a C₂₋₁₂ aliphatic group; wherein the polyester has a melt viscosity between 0.01 and 3,000 poise (0.001 and 300 Pa·s), preferably between 0.02 and 2,600 poise (0.002 and 260 Pa·s), measured at 1500/seconds shear rate, at a temperature of 275° C.; and 0.01 to 4 wt % additives, wherein the weight percentages are based on 100 wt % of the composition; wherein a side of the extruded sheet comprises a surface texture including a plurality of micro-structured units.

Embodiment 27: The textured sheet of embodiment 26, wherein the polyester includes a poly(C₁₋₆ alkylene) terephthalate or a poly(cyclohexane di(C₁₋₆ alkanol) cyclohexyl dicarboxylate) or a copolymer including a poly(C₁₋₆ alkylene)glycol terephthalate and a poly(cyclohexane di(C₁₋₆ alkylene) terephthalate).

Embodiment 28: The textured sheet of embodiment 26 or 27, further including a second composition in direct contact with a side of the extruded sheet, wherein the second composition includes the composition of embodiment 1 or a polycarbonate, a polyarylate, a polystyrene, a polyester, or a combination of at least one of the foregoing.

Embodiment 29: The textured sheet of any one or more of embodiments 26 to 28, wherein the plurality of micro-structured units are lenses, prisms, polyhedral shapes, lenticular shapes, crossing prismatic shapes, pyramidal shapes, corner cubes, cones, or a combination comprising at least one of the foregoing.

This written description uses examples to disclose the invention, and also to enable any person skilled in the art to make and use the invention. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

All ranges disclosed herein are inclusive of the endpoints, and the endpoints are independently combinable with each other (e.g., ranges of “up to 25 weight percent, or more specifically, 5 weight percent to 20 weight percent”, is inclusive of the endpoints and all intermediate values of the ranges of “5 weight percent to 25 weight percent,” etc.). “Combination” is inclusive of blends, mixtures, and the like. The terms “first,” “second,” and the like, herein do not denote any order, quantity, or importance, but rather are used to distinguish one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term. It is to be understood that the described elements may be combined in any suitable manner

In general, the invention may alternately comprise, consist of, or consist essentially of, any appropriate components herein disclosed. The invention may additionally, or alternatively, be formulated so as to be devoid, or substantially free, of any components used in the prior art structures or that are otherwise not necessary to the achievement of the function and/or objectives of the present invention.

“Or” means “and/or” unless clearly stated otherwise. It is to be understood that the described elements may be combined in any suitable manner in the various embodiments.

The description below applies unless otherwise specified. The term “alkyl” includes branched or straight chain, unsaturated aliphatic C₁₋₃₀ hydrocarbon groups e.g., methyl, ethyl, n-propyl, i-propyl, n-butyl, s-butyl, t-butyl, n-pentyl, s-pentyl, n- and s-hexyl, n-and s-heptyl, and, n- and s-octyl. “Alkenyl” means a straight or branched chain, monovalent hydrocarbon group having at least one carbon-carbon double bond (e.g., ethenyl (—HC═CH₂)). “Alkylene” means a straight or branched chain, saturated, divalent aliphatic hydrocarbon group (e.g., methylene (—CH₂—) or propylene (—(CH₂)₃—)). “Cycloaliphatic” includes, for example, cyclopentyl, cyclohexyl, and cycloheptyl. “Aromatic” means contains at least one aromatic moiety. “Aliphatic” means a hydrocarbon group that is straight chained, branched or non-aromatic. “Halogen” means a fluoro, chloro, bromo, iodo, or astatine substituent. “Alkanol” includes an alkyl group containing a hydroxyl (—OH) group. Unless otherwise specified, any group or substituent can be substituted with at least one (e.g., 1, 2, 3, or 4) substituents independently selected from a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(=O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded.

While the invention has been described with reference to an example(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the description disclosed for carrying out this invention, but that the invention will include all falling within the scope of the appended claims.

1. A replication composition, comprising:
at least 45 wt %, of a polycarbonate;
3 to 55 wt %, of a polyester comprising a poly(C₁₋₆ alkylene) terephthalate or a polyester comprising repeating units of Formula 1: 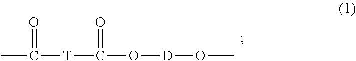
wherein each T is independently a C₅₋₇ cycloaliphatic group or C₆₋₁₂ aromatic group, and each D is independently a C₆₋₁₂ aromatic group or C₂₋₁₂ aliphatic group, provided that at least 50 mole percent of D is a 1,4-cyclohexanedimethyl group or a C₂₋₁₂ aliphatic group; wherein the polyester has a melt viscosity between 0.01 and 3,000 poise (0.001 and 300 Pa·s), measured at 1500/seconds shear rate, at a temperature of 275° C.; and
0.01 to 4 wt % additives;
wherein the weight percentages are based on 100 wt % of the composition.

2. The composition of claim 1, wherein the polyester comprises a poly(C₁₋₆ alkylene) terephthalate, a poly(cyclohexane di(C₁₋₆ alkanol) cyclohexyl dicarboxylate), or a copolymer comprising a poly(C₁₋₆ alkylene)glycol terephthalate and a poly(cyclohexane di(C₁₋₆ alkylene) terephthalate).

3. The composition of claim 1, wherein the additives are UV stabilizers, phosphorous stabilizers, heat stabilizers, antioxidants, hydrolytic stabilizers, mold release agents, extrusion aids, antistatic agents, quenchers, slip agents, coloring agents, lubricants, or a combination comprising at least one of the foregoing.

4. The composition of claim 1, wherein the polycarbonate comprises repeating structural carbonate units of Formula (5): 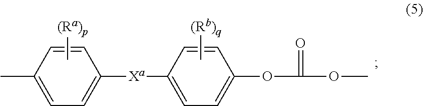
where R^{a} and R^{b} are each independently a halogen atom or a monovalent hydrocarbon group with from 1 to 12 carbon atoms; p and q are each independently integers from 0 to 4; and each X^{a} is independently one of the groups: 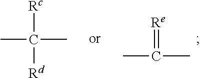
wherein R^{c} and R^{d} are each independently a hydrogen atom or a monovalent linear hydrocarbon group with from 1 to 12 carbon atoms, or a cyclic hydrocarbon group with from 7 to 12 carbon atoms, and R^{e} is a divalent hydrocarbon group with from 1 to 12 carbon atoms.

5. The composition of claim 1, wherein an extruded film comprising the composition has a replication rate of greater than 75%.

6. The composition of claim 1, wherein an extruded film comprising the composition has a melt flow rate of greater than 50 cm³/10 mins as measured according to ASTM D1238-04.

7. The composition of claim 1, wherein an extruded film comprising the composition has a haze of less than 2.2%, as measured according to ASTM D1003-00, Procedure A at 2.54 mm thickness.

8. The composition of claim 1, comprising
45 to 80 wt % of the polycarbonate;
19 to 55 wt % of the polyester; and
0.01 to 2 total wt % of additives.

9. A method of manufacturing a textured sheet comprising:
heating the replication composition of claim 1 to an extrusion temperature of greater than or equal to a glass transition temperature of the replication composition;
extruding the replication composition through a die to form a sheet;
imprinting a surface texture from a transfer surface onto the sheet; and
cooling the sheet below a glass transition temperature of the replication composition to form a textured sheet.

10. The method of claim 9, further comprising forming a layer of a second composition in direct contact with the replication composition, wherein the second composition comprises the composition of any one or more of claims 1 to 8, or a polyarylate, a polystyrene, a polyester, or a combination comprising at least one of the foregoing.

11. The method of claim 9, wherein imprinting occurs before the replication composition is cooled below a glass transition temperature of the replication composition.

12. The method of claim 9, wherein imprinting comprises pressing the sheet between two or more surfaces at a transfer pressure, wherein one of the surfaces comprises the transfer surface.

13. The method of claim 9, wherein imprinting comprises pressing the sheet between two or more rollers at a transfer pressure, wherein a roller comprises the transfer surface disposed along a roller surface.

14. The method of claim 9, wherein cooling occurs within 0.01 to 5 minutes of imprinting; and wherein the cooling is at a rate of 5 to 300° C./minute.

15. A textured sheet made by the method of claim 9.

16. The textured sheet of claim 15, wherein a side of the extruded sheet comprises a surface texture comprising a plurality of micro-structured units.

17. The textured sheet of claim 15, further comprising a second composition in direct contact with a side of the extruded sheet, wherein the second composition comprises the composition of claim 1 or a polycarbonate, a polyarylate, a polystyrene, a polyester, or a combination of at least one of the foregoing.

18. The textured sheet of claim 15, further comprising a second composition in direct contact with a side of the extruded sheet, wherein the second composition is different than the composition of the extruded sheet.

19. An article comprising the textured sheet of claim 15.

20. The article of claim 19, wherein the article is a light module, an LED light cover, or a diffuser/collimating sheet in a back light module in a display application.
